(19) United States
(12) Patent Application Publication
(10) Pub. No.: US 2023/0183121 A1
(43) Pub. Date: Jun. 15, 2023

(54) GLASS BASE MATERIAL PRODUCTION APPARATUS, GLASS BASE MATERIAL PRODUCTION METHOD, AND BASE MATERIAL PROFILE PREDICTION METHOD

(71) Applicant: SUMITOMO ELECTRIC INDUSTRIES, LTD., Osaka-shi, Osaka (JP)

(72) Inventors: Tomohiro ISHIHARA, Osaka-shi, Osaka (JP); Yumiko SAWAI, Osaka-shi, Osaka (JP)

(73) Assignee: SUMITOMO ELECTRIC INDUSTRIES, LTD., Osaka-shi, Osaka (JP)

(21) Appl. No.: 17/924,128

(22) PCT Filed: May 17, 2021
(86) PCT No.: PCT/JP2021/018678

§ 371 Date: Nov. 9, 2022

(30) Foreign Application Priority Data
May 20, 2020 (JP) 2020-088009

(51) Int. Cl. C03B 37/014

(52) U.S. Cl. CPC C03B 37/0142; C03B 2207/70

(57) ABSTRACT

An aspect of the present disclosure enables prediction of a refractive index profile of a transparent glass preform obtained in a production stage of a glass particulate deposit by a VAD method. The glass preform production apparatus includes a gas supply system, a burner, and a signal processing device. The signal processing device includes an imaging device that images a particle flow of glass fine particles, and a calculation unit. The calculation unit extracts, at any one or more time points during a period from the start of production to the end of production of the glass particulate deposit, image data representing a state of at least the flame or the particle flow from an image obtained by the imaging device, and regressively predicts a refractive index profile of the transparent glass preform serving as an objective variable from an explanatory variable including the image data.

This application claims priority from Japanese Patent Application No. 2020 088009 filed on May 20, 2020, the contents of which are relied upon and incorporated herein by reference in its entirety.

### TECHNICAL FIELD

The present disclosure relates to a glass preform production apparatus, a glass preform production method, and a preform profile prediction method.

### BACKGROUND ART

Patent Document 1 discloses monitoring a deposition surface shape of a glass particulate deposit (finally constituting part of an optical fiber preform) by a vapor-phase axial deposition (VAD) method, controlling a pulling speed to achieve a target shape, controlling at least one of a concentration or a flow rate of a gas containing a glass raw material or the like and a burner position together with controlling the pulling speed, and stopping a deposition operation of glass fine particles when deviating from the target shape.

### CITATION LIST

### Patent Literature

Patent Document 1: Japanese Patent Application Laid-Open No. 2012-91965

### SUMMARY OF INVENTION

A glass preform production apparatus according to an embodiment of the present disclosure is an apparatus that produces a glass particulate deposit by a VAD method, and includes a gas supply system, a burner, and a profile prediction system in order to achieve the above object. The gas supply system individually supplies a glass raw material gas and a gas for flame generation (fuel gas). While generating glass fine particles from the glass raw material gas in the flame obtained by combustion of the fuel gas supplied from the gas supply system, the burner blows the glass fine particles in the flame onto the glass particulate deposit. The profile prediction system outputs, at any one or more time points during a period from a start of production to an end of production of the glass particulate deposit, a prediction result of a refractive index profile of the transparent glass preform obtained by dehydrating and sintering the glass particulate deposit. Specifically, the profile prediction system includes an imaging device and a calculation unit. The imaging device images a flame blown from the burner to the glass particulate deposit or a particle flow of glass fine particles generated in the flame. The calculation unit performs an image process of extracting image data representing a state of at least a flame or a particle flow from an image obtained by the imaging device. In addition, the calculation unit regressively predicts the refractive index profile of the transparent glass preform serving as the objective variable from the explanatory variable including at least the image data.

### BRIEF DESCRIPTION OF DRAWINGS

FIG. 1 is a diagram for explaining an object of a glass preform production apparatus, a glass preform production method, and a preform profile prediction method of the present disclosure.

FIG. 2 is a diagram illustrating a configuration example of a glass preform production apparatus according to an embodiment of the present disclosure.

FIG. 3 is a diagram for explaining a burner position with respect to a glass particulate deposit during glass particulate deposition.

FIG. 4 is a diagram for explaining a basic analysis for determining explanatory variables (part 1).

FIG. 5 is a diagram illustrating an example of a schematic configuration of a PC including a calculation unit.

FIG. 6 is a diagram for explaining an image process (contour data extraction) in a calculation unit.

FIG. 7 is a table showing numerical data obtained by the image process of FIG. 6.

FIG. 8 is a diagram for explaining an image process (luminance distribution data extraction) in a calculation unit.

FIG. 9 is a diagram for explaining a basic analysis for determining explanatory variables (part 2).

FIG. 10 is a diagram for explaining an objective variable.

FIG. 11 is a table illustrating explanatory variables and objective variables for each preform sample (transparent glass preform).

FIG. 12 is a table showing prediction results for each objective variable obtained by the preform profile prediction method of the present disclosure.

FIG. 13 is a graph illustrating a correlation between the prediction values and the measured values of an objective variable.

FIG. 14 shows a preform profile predicted by a preform profile prediction method of the present disclosure indicated together with an actually measured preform profile (refractive index profile of a transparent glass preform).

FIG. 15 shows a result of regression prediction of all points of a refractive index profile by an actually measured preform profile and the preform profile prediction method (random forest) of the present disclosure.

### DESCRIPTION OF EMBODIMENTS

### Problem Solved by the Present Disclosure

As a result of studying the above-described conventional technique, the inventors have found the following problems. That is, in the glass preform production method disclosed in Patent Document 1, the deposition shape of a glass particulate deposit by the VAD method is monitored, but it is not possible to predict the refractive index profile of the transparent glass preform obtained by dehydrating and sintering the glass particulate deposit. In the related art, since a refractive index profile of a transparent glass preform obtained from a glass particulate deposit including a portion to be a core of an optical fiber which is a final product greatly affects optical characteristics of the optical fiber, profile measurement is performed before executing a next step.

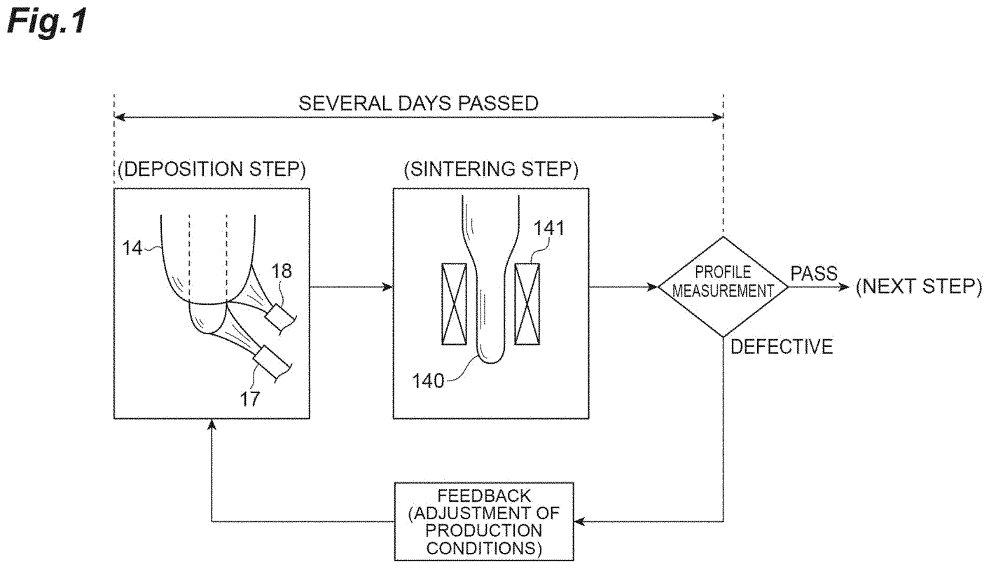

FIG. 1 is a diagram showing operations from a conventional glass preform production method (deposition step) to profile measurement. In the conventional glass preform production method, in the deposition step, a core burner 17 is disposed on the center side of the glass particulate deposit 14, and a cladding burner 18 is disposed on the outer peripheral side, and the glass fine particles are blown from each burner. Thereafter, a glass particulate deposit 14 is heated by a heater 141 to obtain a transparent glass preform 140. The obtained transparent glass preform 140 corresponds a portion corresponding to a core of an optical fiber as a final product and an optical cladding around the core, and is a portion that directly affects optical characteristics of the optical fiber, and a refractive index profile in a radial direction is measured at a plurality of places along a longitudinal direction of the obtained transparent glass preform (profile measurement). As a result of the profile measurement, the transparent glass preform determined to be acceptable proceeds to the next process. On the other hand, when it is determined that the transparent glass preform to be measured is defective as a result of the profile measurement, the production conditions are adjusted in the deposition step (feedback). However, several days usually elapse from the time point of start of the production of the glass particulate deposit 14 to the time point of ending the profile measurement. When the profile-measured transparent glass preform 140 is determined to be defective, all of the glass products produced in the last several days, that is, all or part of the glass particulate deposit 14 and the transparent glass preform 140 produced before the production conditions are adjusted may be determined to be defective. As described above, it is difficult to improve the production yield in the glass preform production method according to the above-described conventional technique.

The present disclosure has been made to solve the above-described problems, and an object of the present disclosure is to provide a glass preform production apparatus, a glass preform production method, and a preform profile prediction method capable of predicting a refractive index profile of a transparent glass preform including a portion to be a core of an optical fiber as a final product in a production stage of a glass particulate deposit before sintering.

### Effects of the Present Disclosure

According to various embodiments of the present disclosure, it is possible to predict the profile of the transparent glass preform over the entire length of the transparent glass preform. In addition, such profile prediction in the middle of the production of the glass particulate deposit makes it possible to change the production conditions and effectively suppress the occurrence of characteristic defects due to structural defects of the optical fiber as a final product.

### Description of the Embodiment of the Present Disclosure

First, contents of embodiments of the present disclosure will be individually listed and described.

(1) A glass preform production apparatus according to an embodiment of the present disclosure is an apparatus that produces a glass particulate deposit (including a portion to be a core of an optical fiber as a final product) by a VAD method, and includes, as an aspect thereof, a gas supply system, a burner, and a profile prediction system. The gas supply system individually supplies a glass raw material gas and a gas for flame generation (fuel gas). While generating the glass fine particles from the glass raw material gas in the flame obtained by combustion of the fuel gas supplied from the gas supply system, the burner blows the glass fine particles generated in the flame onto the glass particulate deposit. The profile prediction system outputs, at any one or more time points during a period from a start of production to an end of production of the glass particulate deposit, a prediction result of a refractive index profile of the transparent glass preform obtained by dehydrating and sintering the glass particulate deposit.

Specifically, the profile prediction system includes an imaging device and a calculation unit. The imaging device images a flame blown from the burner to the glass particulate deposit or a particle flow of glass fine particles generated in the flame. The calculation unit performs an image process of extracting image data representing a state of at least a flame or a particle flow from an image obtained by the imaging device. In addition, the calculation unit regressively predicts the refractive index profile of the transparent glass preform serving as the objective variable from the explanatory variable including the image data. Note that the image data representing the state of the particle flow includes contour information about the flame or the particle flow, luminance information about light arriving from the flame or the particle flow, and the like specified by an image obtained by imaging the flame or the particle flow.

As described above, the prediction of the refractive index profile of the transparent glass preform is performed at any one or more time points during the period from the start of production to the end of production of the glass particulate deposit. Therefore, the profile of the transparent glass preform can be predicted over the entire length of the transparent glass preform. In addition, such profile prediction in the middle of the production of the glass particulate deposit makes it possible to change the production conditions, and to effectively suppress characteristic defects caused by structural defects of the optical fiber as a final product.

More specifically, the glass preform production apparatus or the like of the present disclosure makes it possible to predict a refractive index profile of a main portion of an optical fiber preform finally obtained (a portion including a portion to be a core of an optical fiber), that is, a transparent glass preform obtained by dehydrating and sintering a glass particulate deposit, during the production of the glass particulate deposit. This means that the production conditions of the transparent glass preform can be adjusted before the profile measurement, so that the number of defectives of the transparent glass preform can be reduced. In addition, it is possible to make process engineers less skilled and shorten the feedback time for adjustment of production conditions.

Furthermore, according to the glass preform production apparatus and the like of the present disclosure, since the refractive index profile of the glass preform can be controlled to have a desired profile shape over the entire length of the preform, the characteristics of the obtained transparent glass preform can be stabilized to desired characteristics. In addition, by producing an optical fiber as a final product from an optical fiber preform containing such a transparent glass preform, the optical characteristics of the optical fiber can be stabilized to desired characteristics.

(2) The glass preform production method of the present disclosure is a method for producing a glass particulate deposit by a VAD method, and is realized by the above-described glass preform production apparatus. Specifically, the glass preform production method includes, as an aspect thereof, a gas supply step, a deposition step, and a prediction step. In the gas supply step, the glass raw material gas and the fuel gas are individually supplied to the burner. The deposition step includes generating the glass fine particles from the glass raw material gas in the flame obtained by the combustion of the fuel gas supplied to the burner and blowing the glass fine particles generated in the flame onto the glass particulate deposit. The prediction step includes predicting, at any one or more time points during the period from the start to the end of the deposition step, a refractive index profile of the transparent glass preform obtained by dehydration and sintering of the glass particulate deposit. Specifically, the prediction step includes an imaging step and a calculation step. The imaging step includes imaging a flame blown from the burner to the glass particulate deposit or a particle flow of glass fine particles generated in the flame. The calculation step includes extracting at least image data representing the state of the flame or the particle flow from the image obtained in the imaging step. Further, a refractive index profile of the transparent glass preform serving as an objective variable is regressively predicted from the explanatory variable including the extracted image data. The glass preform production method also achieves the effect same as that of the above-described glass preform production apparatus.

(3) The preform profile prediction method of the present disclosure is a method applicable to the above-described glass preform production apparatus and glass preform production method, and the method includes predicting, at any one or more time points during a period from the start of production to the end of production of a glass particulate deposit, a refractive index profile of a transparent glass preform obtained by dehydration and sintering of the glass particulate deposit produced by a VAD method. Specifically, the preform profile prediction method includes, as an aspect, an imaging step, an image processing step, and a calculation step. The imaging step includes imaging a flame blown from the burner to the glass particulate deposit or a particle flow of glass fine particles generated in the flame. This flame or particle flow imaging (imaging step) includes generating the glass fine particles from the glass raw material gas supplied to the burner in a flame obtained by combustion of the fuel gas supplied to the burner and performing imaging at any time points when the glass fine particles generated in the flame are blown onto the glass particulate deposit. The image processing step includes extracting image data representing the state of the flame or the particle flow from the image obtained in the imaging step. The calculation step includes regressively predicting the refractive index profile of the transparent glass preform serving as the objective variable from the explanatory variable including at least the image data extracted in the image processing step. The preform profile prediction method also achieves the effect same as that of the above-described glass preform production apparatus.

(4) As an aspect of the present disclosure, the explanatory variable preferably includes contour data of at least a flame or a particle flow in the flame. As will be described later as an example, this is because a high correlation can be confirmed between the contour data of the particle flow and the shape of the refractive index profile of the transparent glass preform by the basic analysis (the same applies to the contour data of the flame). Furthermore, as an aspect of the present disclosure, it is preferable that the explanatory variables further include at least any one of luminance distribution data of the flame or the particle flow, data obtained by quantifying an installation position and an installation angle of the burner, flow rate data of the glass raw material gas to be introduced into the burner, flow rate data of the fuel gas, a temperature (sintering temperature) in a heating furnace during the dehydration and sintering, and a gas flow rate to be supplied into the heating furnace during the dehydration and sintering. Since the data can confirm a high correlation with the refractive index profile of the transparent glass preform, it is possible to perform profile prediction with higher accuracy by including the data as explanatory variables.

(5) As an aspect of the present disclosure, the objective variable preferably includes a refractive index profile of the transparent glass preform or one or more types of data characterizing the refractive index profile of the transparent glass preform. Note that this refractive index profile is a distribution of the relative refractive index difference along the radial direction (direction orthogonal to the preform center axis) of the transparent glass preform. In this case, it is possible to visually display the prediction result.

(6) As an aspect of the present disclosure, in the calculation unit or the calculation step, a refractive index profile or one or more types of data characterizing the refractive index profile is set as an objective variable, a learning model is constructed in advance using a regression analysis including at least one of decision tree regression, random forest (RF), gradient boosting, multiple regression, and Lasso regression for each objective variable, and the objective variable is predicted using the constructed learning model (regression prediction). This learning model is a prediction model in which a correlation between an explanatory variable and an objective variable is constructed using known data. As described above, as the regression prediction, a regression analysis including at least one or more of decision tree regression, random forest, gradient boosting, multiple regression, and Lasso regression is preferably executed for each objective variable. The profile can be predicted with high accuracy by applying the regression analysis suitable for prediction for each objective variable.

(7) As an aspect of the present disclosure, the glass preform production apparatus having the above-described structure may further include a filter disposed between the imaging device and a space sandwiched between the glass particulate deposit and the burner. This filter transmits light with a predetermined wavelength from a flame or particle flow. For example, in the case of imaging thermal radiation light from a flame or a particle flow, the load of an image process is reduced by removing light with an unnecessary wavelength.

As described above, each aspect listed in the section of [Description of the embodiment of the present disclosure] is applicable to each of all the remaining aspects or to all combinations of these remaining aspects.

### Details of Embodiments of the Present Disclosure

Hereinafter, specific structures of the glass preform production apparatus, the glass preform production method, and the preform profile prediction method of the present disclosure will be described in detail with reference to the accompanying drawings. Note that the present invention is not limited to these exemplifications, is shown by the claims, and is intended to include all modifications within the meaning and scope equivalent to the claims. Note that in the description of the drawings, the same elements are denoted by the same reference numerals, and duplicate explanation is omitted.

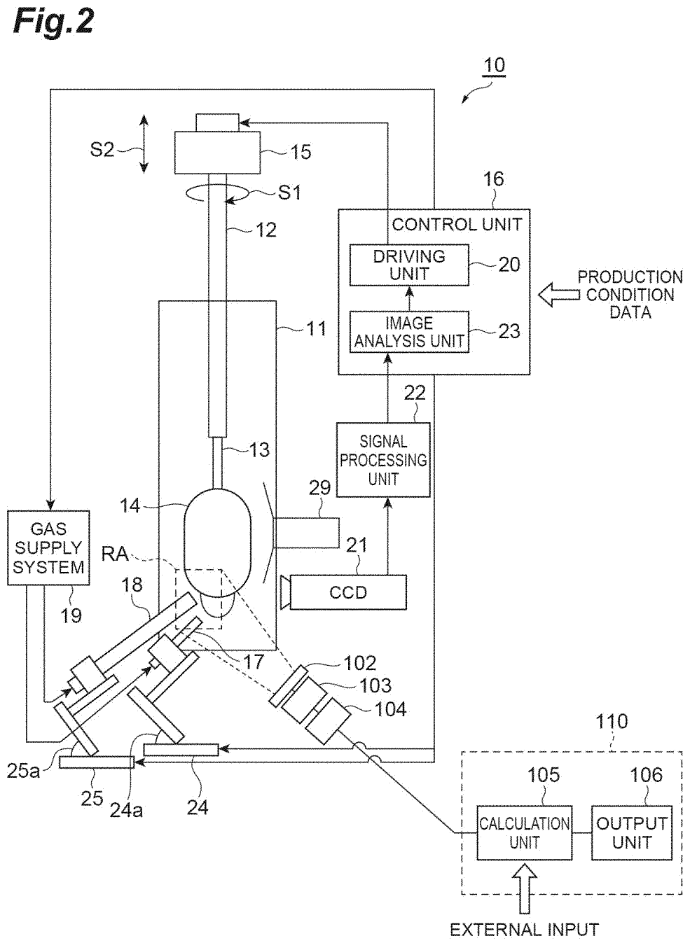

FIG. 2 is a diagram illustrating a configuration example of a glass preform production apparatus (an apparatus that implements a glass preform production method according to an embodiment of the present disclosure) according to an embodiment of the present disclosure. A basic configuration of a glass preform production apparatus 10 shown in FIG. 2 is substantially similar to the device configuration shown in Patent Document 1, but is not limited to the device configuration shown in Patent Document 1, and a device configuration similar to a general glass preform production apparatus can be applied. The glass preform production apparatus 10 according to the present embodiment is different from the apparatus configuration described in Patent Document 1 and the apparatus configuration of a general glass preform production apparatus in that it includes a profile prediction system in addition to the basic configuration as described above. That is, the glass preform production apparatus 10 according to the present embodiment mainly includes a configuration for performing a deposition step (reactor, gas supply system, burner, driving unit, and the like), a configuration for controlling the deposition step (control unit, image analysis unit, driving unit, etc.), and a configuration for predicting a refractive index profile of a transparent glass preform obtained after dehydration and sintering from a deposited state of glass fine particles (profile prediction system including a calculation unit and the like).

The glass preform production apparatus 10 according to the present embodiment includes a reactor 11 for producing the glass particulate deposit 14. The reactor 11 includes an exhaust duct 29, and the core burner 17, the cladding burner 18, and part of a support rod 12 having one end to which a starting glass rod for depositing glass fine particles is attached are located in the reactor 11. As an example, a glass rod comprised of silica glass having a diameter of 25 mm and a length of 400 mm is applied as the starting glass rod.

The other end of the support rod 12 is supported by a lifting and lowering rotation device 15, and the lifting and lowering rotation device 15 rotates the support rod 12 along an arrow S1 in FIG. 2 and lifts and lowers the support rod 12 along a direction indicated by an arrow S2. The operation of the lifting and lowering rotation device 15 is controlled by a driving unit (lifting speed control unit) 20 constituting part of a control unit (control device) 16. The control unit 16 individually performs gas flow rate control for a gas supply system 19, position control of a core burner stage 24 and an angle adjustment mechanism 24a provided on the core burner stage 24, and position control of a cladding burner stage 25 and an angle adjustment mechanism 25a provided on the cladding burner stage 25 according to control conditions inputted from the outside.

In the example of FIG. 2, the core burner 17 has five pipes (disposed concentrically) having different outer diameters. Into the smallest diameter pipe (innermost pipe), the glass raw material gases (SiCl₄, GeCl₄, and O₂) supplied from the gas supply system 19 are introduced. A burner seal gas (N₂) is introduced into the space in the second innermost pipe, a fuel gas (H₂) is introduced into the space in the third innermost pipe, a burner seal gas (N₂) is introduced into the space in the fourth innermost pipe, and a combustible assist gas (O₂) is introduced into the space in the fifth innermost pipe. In the flame of the core burner 17, glass fine particles (SiO₂) and a refractive index adjusting dopant (GeO₂) are generated by a hydrolysis reaction and a combustion reaction of the glass raw material gas described below, and the glass fine particles generated in the flame are blown from the core burner 17 to the glass particulate deposit 14. The burner seal gas is a gas introduced to prevent thermal degradation of the burner distal end and deposition of glass fine particles at the burner distal end, and functions to separate the glass raw material gas, the fuel gas, and the combustible assist gas from each other near the pipe end of the core burner 17.

SiCl₄+2H₂O→SiO₂+4HCl

GeCl₄+O₂→GeO₂+2Cl₂

Note that the structure of the cladding burner 18 is substantially similar to the structure of the core burner 17 described above, but the type of the raw material of the refractive index adjusting dopant contained in the glass raw material gas supplied from the gas supply system 19 is different. For example, when fluorine (F) is added to the cladding portion as a refractive index adjusting dopant, the glass raw material gas contains CF₄ together with SiCl₄. However, in a case where the refractive index of the cladding portion is not adjusted, the glass raw material gas may not contain the raw material of the refractive index adjusting dopant.

In the glass preform production apparatus 10, the deposition surface shape of a portion (specifically, a periphery of a portion to be a core of the optical fiber) of the glass particulate deposit 14 is monitored by a measuring camera (CCD camera) 21. A signal processing unit (image processing unit) 22 outputs video data generated based on the electrical signal from the measuring camera 21 to an image analysis unit (deposition shape measurement unit) 23 constituting part of the control unit 16. The image analysis unit 23 divides the video data (moving image) into two-dimensional images (still images), and extracts the deposition surface shape from the obtained two-dimensional images (still images). Then, the image analysis unit 23 performs drive control on the driving unit 20 so that the extracted deposition surface shape is a target shape (outputs a corrected drive control signal to the driving unit 20). Further, the image analysis unit 23 calculates the correction amount of the concentration and the flow rate of the gas containing the glass raw material and the like and the correction amount of the burner position so that the deposition surface shape is the target shape. The control unit 16 controls the gas supply system 19, the core burner stage 24, and the cladding burner stage 25 according to the correction amount obtained by the image analysis unit 23.

The glass preform production apparatus 10 according to the present embodiment further includes a profile prediction system configured to output, at any one or more time points during a period from a start of production to an end of production of the glass particulate deposit 14, a prediction result of a refractive index profile of the transparent glass preform 140 (see FIG. 1) obtained by dehydration and sintering of the glass particulate deposit 14. In an example, a profile prediction (the preform profile prediction method of the present disclosure) is performed at 36000 points (1 second intervals) that are spaced apart from one another along the longitudinal direction of the glass particulate deposit 14.

As illustrated in FIG. 2, the profile prediction system includes a filter 102, a CCD camera (imaging device) 103, a signal processing unit 104, a calculation unit 105, and an output unit 106 such as a display. Note that at least the calculation unit 105 and the output unit 106 can be configured by a personal computer (hereinafter, referred to as a “PC”) 110. The filter 102 is disposed between the CCD camera 103 and a space sandwiched between the glass particulate deposit 14 and the core burner 17, and transmits light with a predetermined wavelength (for example, a portion of the thermal radiation light from the particle flow) from the particle flow in the burner flame. Specifically, the load of an image process is reduced by removing light with an unnecessary wavelength. As an example, the sampling interval by the CCD camera 103 is about 0.1 seconds to 1 second. The shutter speed falls within the range of from 0.1 ms to 1000 ms.

Furthermore, in the profile prediction system, the calculation unit 105 performs the image process of extracting image data representing a state of at least the flame or the particle flow from a two-dimensional image obtained by the imaging device. As an example, the image process in the calculation unit 105 is performed using image analysis software, and specifically, the contour of the flame or the particle flow is clarified after the two-dimensional image from the signal processing unit 104 is adjusted in luminance. In addition, the calculation unit 105 regressively predicts a refractive index profile of the transparent glass preform 140, serving as an objective variable, from the explanatory variable including data obtained by coordinating the contour of at least the flame or the particle flow. More specifically, contour data of the flame or the particle flow, a burner installation position (burner installation position and burner installation angle along the burner X-axis), a flow rate of a glass raw material gas (including a raw material of a refractive index adjusting dopant), a flow rate of a fuel gas (H₂), a flow rate of a combustible assist gas (O₂), conditions of dehydration and sintering when the glass particulate deposit 14 is made into transparent glass (temperature, gas flow rate), and the like are set as explanatory variables, and data characterizing a refractive index profile is set as an objective variable. Incidentally, the dehydration and sintering step is a step of transparently vitrifying the glass particulate deposit 14 in a heating furnace, and is a step of heating the glass particulate deposit 14 by a heater disposed outside a core tube while supplying at least one kind of gas selected from, for example, nitrogen, argon, helium, chlorine or the like into the core tube housing the glass particulate deposit 14, thereby dehydrating and sintering (making transparent) the glass particulate deposit 14. The “gas flow rate” as a condition for dehydration and sintering means a flow rate of the gas to be supplied into the core tube in the dehydration and sintering step. After determining the explanatory variable and the objective variable, the calculation unit 105 models in advance the correlation between the contour of the flame or the particle flow and the refractive index profile by using decision tree regression, random forest (RF), gradient boosting, multiple regression, lasso regression, or the like. During the production of the glass particulate deposit 14, the calculation unit 105 predicts the refractive index profile of the transparent glass preform 140 using the learning model (prediction model) constructed in this manner Note that the image data representing the state of the flame or the particle flow includes contour data of the flame or the particle flow or luminance information about thermal radiation light from the particles, which is specified by a two-dimensional image obtained by imaging the particle flow.

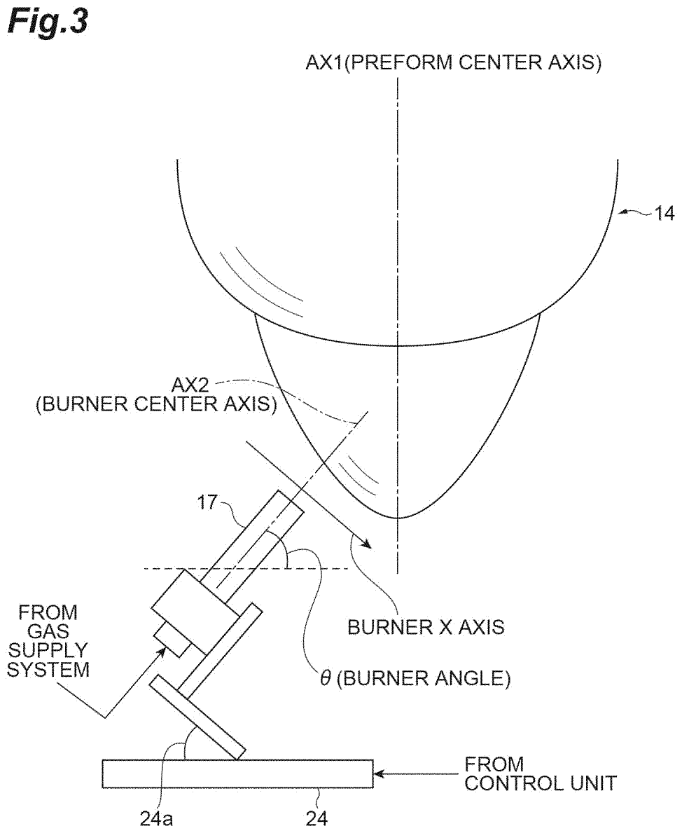

FIG. 3 is a diagram for describing a burner position with respect to the glass particulate deposit 14 during glass particulate deposition. As shown in FIG. 3, the glass particulate deposit 14 and the core burner 17 are disposed such that a preform center axis AX1 and a burner center axis (substantially the center axis of the pipe) AX2 cross each other. Such a relative positional relationship also applies to the positional relationship between the glass particulate deposit 14 and the cladding burner 18. The core burner stage 24 moves the burner center axis AX2 along the burner X-axis. The angle adjustment mechanism 24a adjusts an angle (burner angle θ) of the core burner with respect to the core burner stage 24.

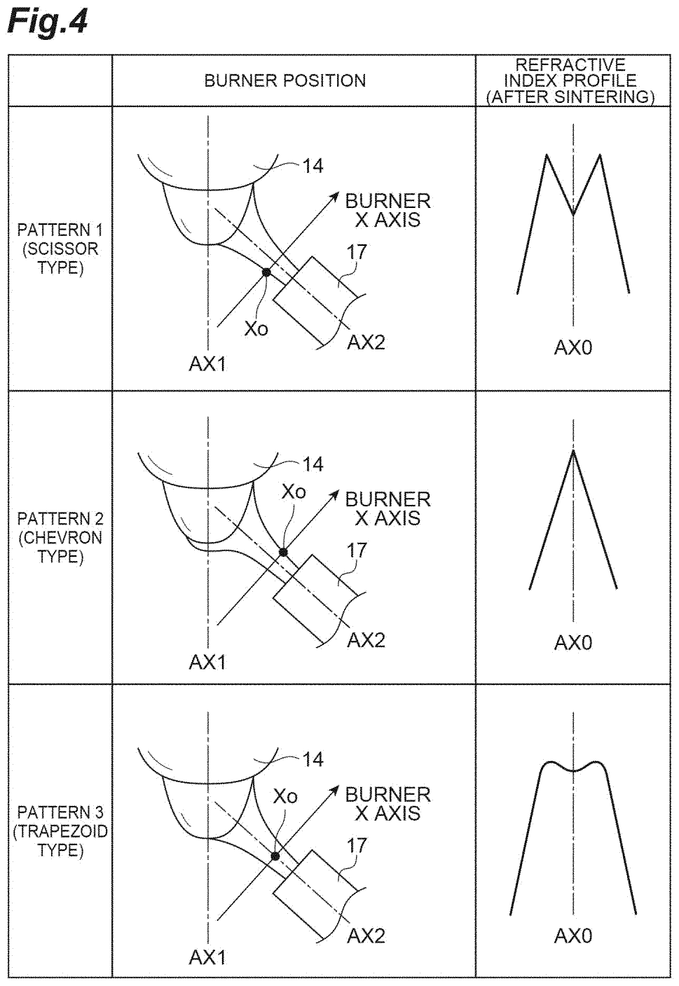

FIG. 4 is a diagram for describing a basic analysis that is a basis for determining contour data (which may be luminance distribution data) of a particle flow and a burner position as explanatory variables as an example. FIG. 4 is a view illustrating a relationship between a contour change (patterns 1 to 3) of a particle flow (Glass fine particle group in flame blown from core burner 17 to glass particulate deposit 14) adjusted by a positional relationship between the glass particulate deposit 14 and the core burner 17 and a refractive index profile of the transparent glass preform 140 obtained by dehydrating and sintering the glass particulate deposit 14 (refractive index profile along a diameter direction orthogonal to the center axis AX0 of the transparent glass preform 140).

In FIG. 4, a right column of the pattern 1 shows a scissor type refractive index profile as a schematic shape of a refractive index profile of transparent glass preform 140 obtained after dehydration and sintering. In pattern 1, as shown in the left column, the core burner 17 is disposed such that the burner center axis AX2 of the core burner 17 is shifted upward (a position closer to the starting glass rod 13 than X₀) with respect to the origin X₀ of the burner X-axis. By disposing the core burner 17 at such a position with respect to the glass particulate deposit 14, it is easy to obtain a scissor type refractive index profile having each refractive index peak at a position away from the center axis AX0 of the transparent glass preform 140 after dehydration and sintering.

The right column of the pattern 2 shows a chevron type refractive index profile as a schematic shape of a refractive index profile of the transparent glass preform 140 obtained after dehydration and sintering. In the pattern 2, as shown in the left column, the core burner 17 is disposed such that the burner center axis AX2 of the core burner 17 is shifted downward (a position farther from the starting glass rod 13 than the origin X₀) with respect to the origin X₀ of the burner X-axis. By disposing the core burner 17 at such a position with respect to the glass particulate deposit 14, it is easy to obtain a chevron type refractive index profile having a refractive index peak at the center of the core coinciding with the center axis AX0 of the transparent glass preform 140 after dehydration and sintering.

The right column of the pattern 3 shows a trapezoid type refractive index profile as a schematic shape of a refractive index profile of the transparent glass preform 140 obtained after dehydration and sintering. In the pattern 3, as shown in the left column, the core burner 17 is disposed such that the burner center axis AX2 of the core burner 17 intersects the origin X₀ of the burner X-axis. By disposing the core burner 17 at such a position with respect to the glass particulate deposit 14, it is easy to obtain a trapezoid type refractive index profile having a small refractive index variation in a peripheral region around the center axis AX0 of the transparent glass preform 140 after dehydration and sintering.

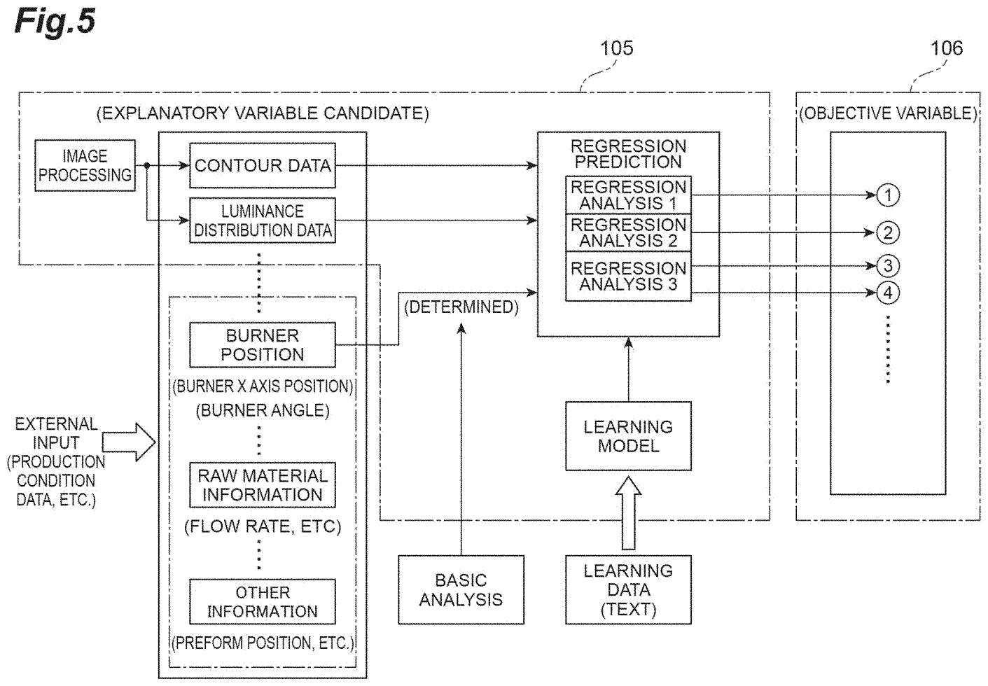

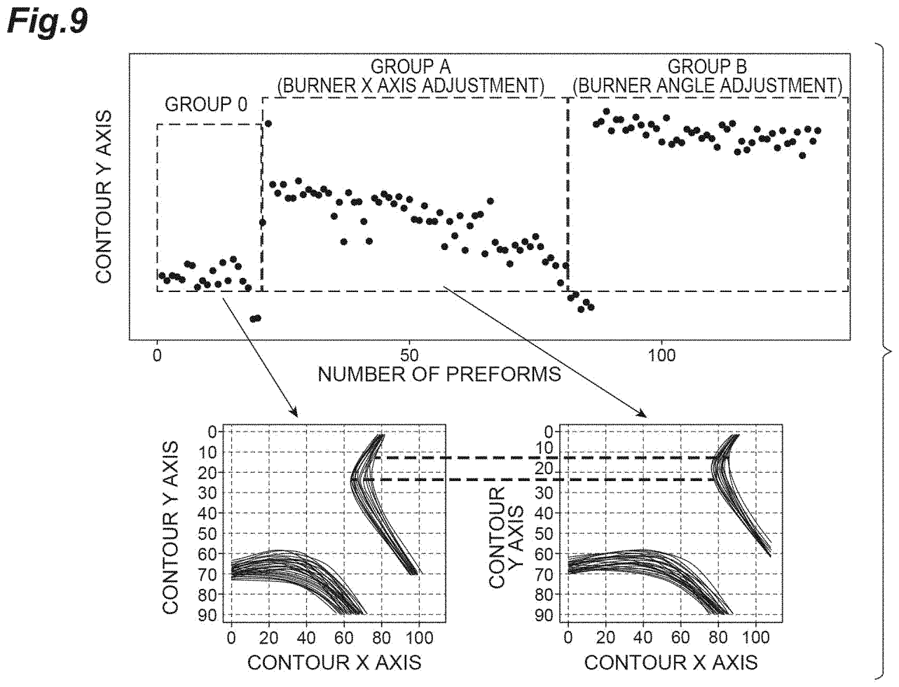

FIG. 5 is a diagram illustrating an example of a schematic configuration of the PC 110 including the calculation unit 105. In the calculation unit 105, the image process for capturing the image signal from the signal processing unit 104 and extracting an explanatory variable (contour data of the flame or the particle flow, luminance distribution data of the flame or the particle flow, and the like) is performed. The explanatory variable is determined through the basic analysis as illustrated in FIG. 4, and examples of the explanatory variable candidate include contour data of the flame or the particle flow, luminance distribution data of the flame or the particle flow, an installation position of the core burner 17 (burner X-axis position, burner angle θ, etc.), a flow rate of the glass raw material gas, a flow rate of fuel gas for flame generation, and the like. As other information, a deposition surface shape, conditions of dehydration and sintering (including temperature, gas flow rate, and the like), and the like can also be candidates for explanatory variables. The contour data is obtained by performing the image process in advance, but other information is inputted from the outside as production condition data. In the present embodiment, the contour data of the particle flow present in the flame, the luminance distribution data of the particle flow, and the burner installation position (burner X-axis position and burner angle) are determined as explanatory variables based on the results of the basic analysis shown in FIGS. 4 and 9.

The calculation unit 105 constructs a correlation between the explanatory variable and the objective variable by the learning model by utilizing the explanatory variable and the objective variable obtained in the past manufacturing, has a memory storing the constructed learning model, and performs regression prediction using the learning model. In the regression prediction, arbitrarily selected regression analysis (In the example of FIG. 5, regression analysis 1 to regression analysis 3) is performed for each objective variable. As the regression analysis, for example, decision tree regression, random forest, gradient boosting, multiple regression, Lasso regression, or the like can be applied.

In general, the random forest is an analysis method in which the process of randomly selecting learning data and constructing a decision tree is performed a plurality of times, and classification and regression are performed by a majority decision or an average value of estimation results of each decision tree. Specifically, the random forest is referred to as ensemble learning because a plurality of learning models (decision trees) is used.

The gradient boosting is an analysis method in which a decision tree analysis is first performed, and a process of constructing a decision tree for an error between a prediction value and a true value of a constructed decision tree model is repeated a plurality of times. Like the random forest, it is ensemble learning, but random forest creates decision trees in parallel, whereas gradient boosting configures decision trees in series.

The multiple regression analysis is an analysis method for predicting one objective variable with a plurality of explanatory variables (numerical values). For example, when one objective variable is represented by y and n (n is an integer of 1 or more) explanatory variables are represented by xi (i is an integer from 1 to n), the multiple regression analysis is given by the following Formula (1).

y=a1×x1+a2×x2+ . . . +an×xn+b (1)

where ai (i is an integer from 1 to n) is a regression coefficient, and b is an intercept. A learning model is constructed by determining the regression coefficient ai and the intercept b using a plurality of pieces of learning data in which the objective variable y and the explanatory variable xi are known.

The Lasso regression analysis is an analysis model in which “L1 regularization” is added to linear regression as in the above-described multiple regression analysis. In the Lasso regression analysis, since the regression coefficient for data that is less likely to affect prediction is brought close to zero, only substantially important explanatory variables are selected for the regression analysis.

In the present embodiment, the objective variable obtained by the regression prediction is a refractive index profile of the transparent glass preform 140 or data characterizing the refractive index profile. The output unit 106 includes a monitor or the like that reproduces a refractive index profile predicted by regression.

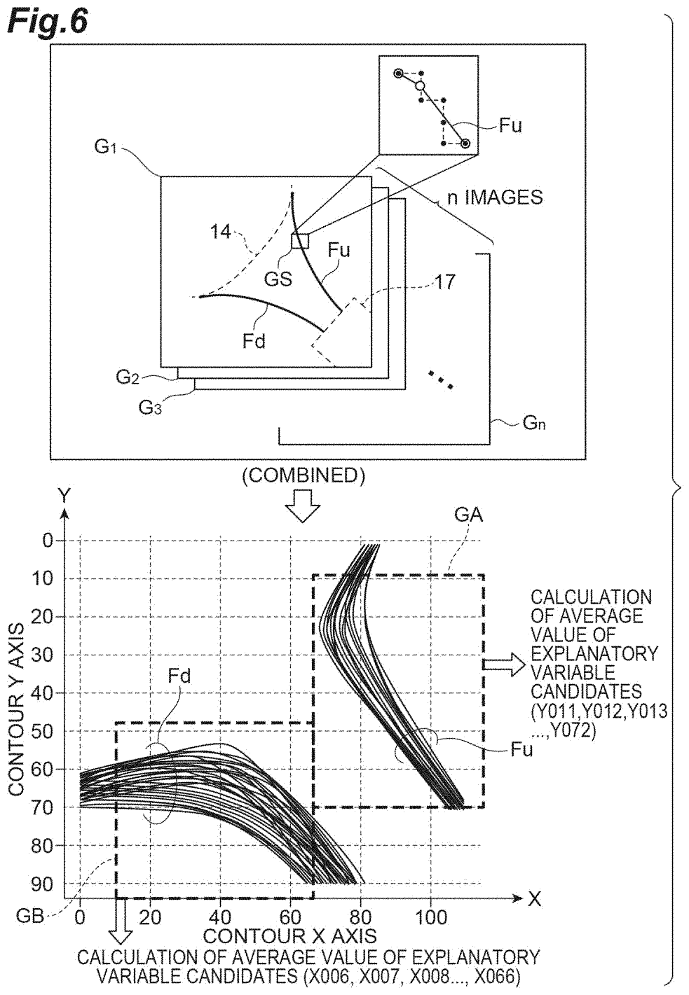

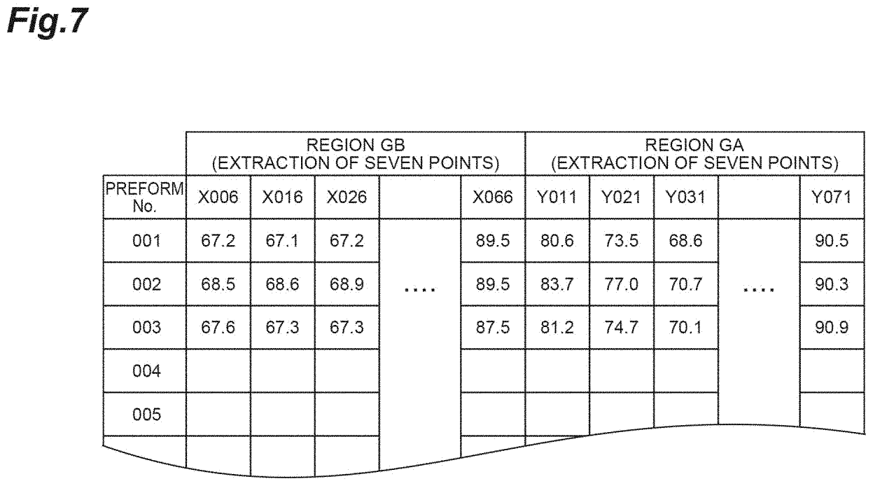

FIG. 6 is a diagram for explaining the image process (contour data extraction) in the above-described calculation unit 105. FIG. 7 is a table illustrating numerical data obtained by the image process of FIG. 6.

The calculation unit 105 takes in video data (moving image) outputted from the signal processing unit 104, divides the data into n (an integer of 1 or more) two-dimensional still images Gi (i is an integer from 1 to n), and extracts contour data (image data) of a particle flow in flame blown from the core burner 17 to the glass particulate deposit 14 for each two-dimensional still image. Specifically, as illustrated in the upper part of FIG. 6, the two-dimensional still image Gi is an image obtained by imaging the imaging area RA illustrated in FIG. 2 by the CCD camera 103, and a necessary region is cut out. The contour data of the particle flow is extracted after a luminance adjustment of the cut-out region. As illustrated in the upper part of FIG. 6, the extracted contour data is composed of an upper contour Fu and a lower contour Fd. Finally, each of the contours Fu and Fd is subjected to the smoothing processing. Note that in the upper part of FIG. 6, the smoothing process of the upper contour Fu located in the region GS is shown. When the above-described contour data extraction is completed for n two-dimensional still images, n contour coordinates are obtained. The lower part of FIG. 6 is a graph of n contour coordinates (the horizontal axis represents a “contour X-axis”, and the vertical axis represents a “contour Y-axis”). The table of FIG. 7 summarizes the results of averaging the n contour coordinates for each preform sample.

In the graph illustrated in the lower part of FIG. 6, a region GA including the n upper contours Fu is a region defined by coordinates Y011 to Y072 (hereinafter, it is referred to as an “explanatory variable candidate”) on the contour Y-axis. For each of the explanatory variable candidates Y011 to Y072, the contour coordinate average value of the n upper contours Fu on the contour X-axis is calculated. On the other hand, a region GB including the n lower contours Fd is a region defined by coordinates X006 to X066 (hereinafter, it is referred to as an “explanatory variable candidate”) on the contour X-axis. For each of the explanatory variable candidates X006 to X066, the contour coordinate average value of the n lower contours Fd on the contour Y-axis is calculated. In the example of FIG. 7, as the explanatory variables for each preform sample, the contour coordinate average value of each of seven candidates (Y011, Y021, . . . , Y071) extracted from the explanatory variable candidates Y011 to Y072 that define the region GA, and the contour coordinate average value of seven candidates (X006, X016, . . . , X066) extracted from the explanatory variable candidates X006 to X066 that define the region GB are set.

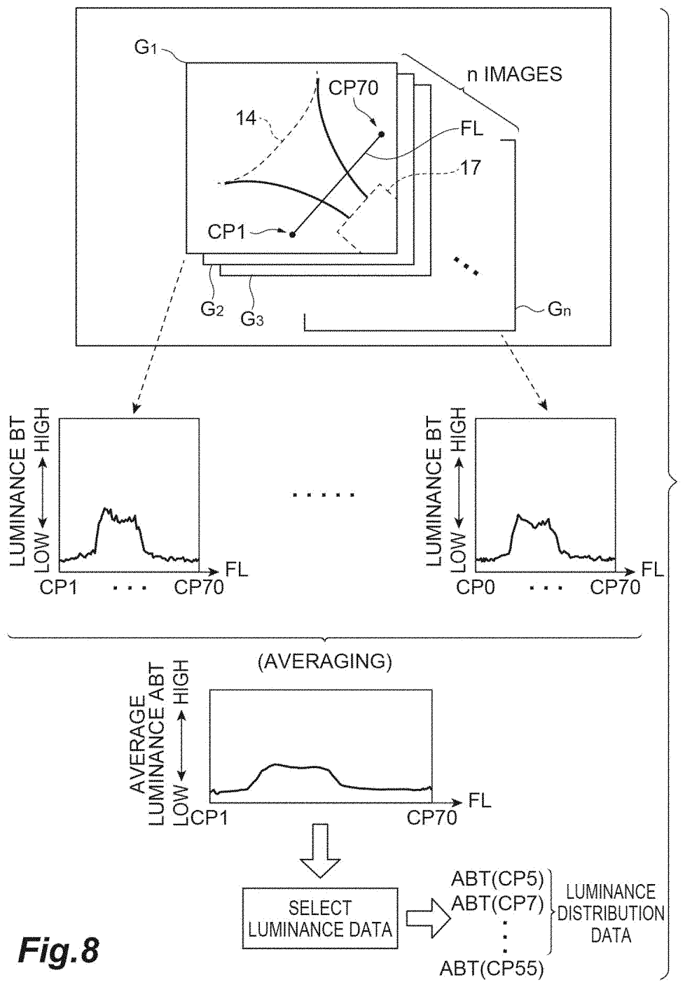

Furthermore, in the image process in the calculation unit 105 described above, as illustrated in FIG. 8, luminance distribution data is extracted for each two-dimensional still image as an explanatory variable. Note that FIG. 8 is a diagram for explaining the image process (luminance distribution data extraction) in the calculation unit 105.

As in the contour data extraction operation described above, the calculation unit 105 takes in the video data (moving image) outputted from the signal processing unit 104, divides the data into n (an integer of 1 or more) two-dimensional still images Gi (i is an integer of 1 to n), and extracts, for each two-dimensional still image, the luminance distribution of the particle flow generated in the flame blown from the core burner 17 to the glass particulate deposit 14. Specifically, as illustrated in the upper part of FIG. 8, the two-dimensional still image Gi is an image obtained by imaging the imaging area RA illustrated in FIG. 2 by the CCD camera 103, and a necessary region is cut out. For example, the luminance distribution of the particle flow in the two-dimensional still image Gi is defined as luminance BT (CPx) at respective points (70 luminance measurement points in the example of FIG. 8) on the line segment FL connecting the start point CP1 and the end point CP 70 on the two-dimensional still image Gi. Here, x is any integer from 1 to 70. The average luminance ABT (CPx) is obtained by averaging the luminance BT (CPx) obtained from each of the n two-dimensional still images at the same luminance measurement point.

The obtained average luminance ABT (CPx) indicates an average luminance distribution at a total of 70 locations of CP1 to CP 70 on the line segment FL. Further, the luminance distribution data prepared as the explanatory variable is configured by, for example, the average luminance ABT (CPx) at 40 locations arbitrarily selected from the CP1 to the CP 70. Note that the number of luminance measurement points selected from the luminance measurement points on the line segment FL is not limited to 40, and for example, the number of optimal luminance distribution data configurations (the number of luminance measurement points) may be determined by evaluating each luminance distribution configured at 5, 10, 20, and 40 locations.

FIG. 9 is a diagram for describing the basic analysis that is the basis for determining the burner position as the explanatory variable. As shown in FIG. 5, in the present embodiment, not only the contour data of the particle flow but also the burner installation position (burner X-axis position and burner angle θ) of the core burner 17 are used as explanatory variables. The upper part of FIG. 9 illustrates a trend graph of the contour Y-axis value at which the contour-X axis value of the upper contour Fu of the particle flow is minimized for each preform. The group A is a preform group in which the position of the core burner 17 is moved along the burner X-axis with respect to the group 0, and the group B is a preform group in which the angle of the core burner 17 is further adjusted. In the lower part of FIG. 9, it can be seen that the flame contour moves upward, and the contour Y-axis value at which the contour X-axis value of the upper contour Fu is minimized changes in the group A, compared with those in the group 0 in which the core burner 17 is in the standard position. Therefore, in the present embodiment, the burner installation position (burner X-axis position and burner angle θ) is also added to the explanatory variables.

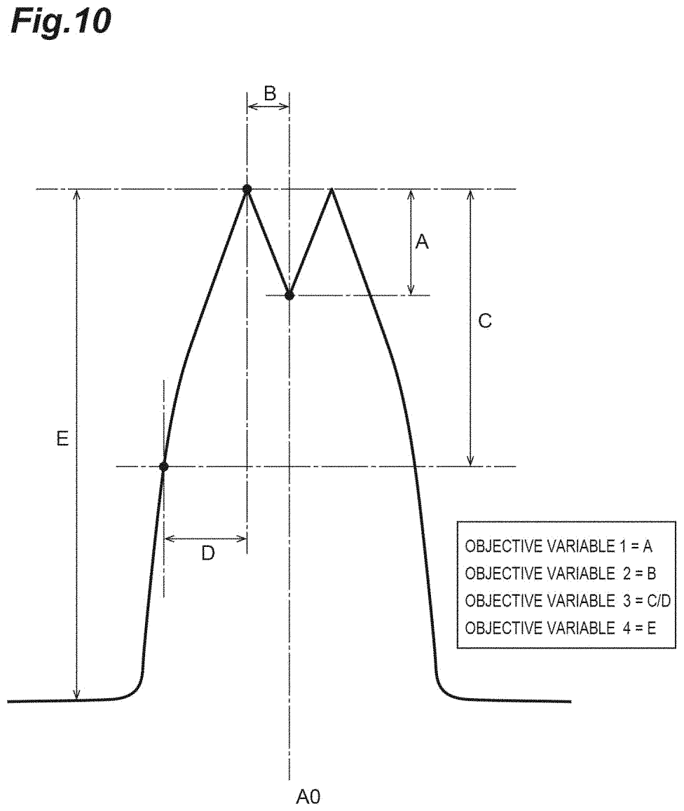

FIG. 10 is a diagram for describing an objective variable. In the present embodiment, a refractive index profile of the transparent glass preform 140 obtained by dehydrating and sintering a glass particulate deposit 14 on which glass fine particles are deposited by a VAD method is predicted. As an example, four types of data that characterize the refractive index profile to be predicted are objective variables.

Four types of data characterizing the refractive index profile will be described with reference to FIG. 10. An objective variable 1 (feature amount “A”) represents a difference between the maximum relative refractive index difference and a relative refractive index difference of the center axis A0. An objective variable 2 (feature amount “B”) represents a distance from the center axis A0 to a radial position where the maximum relative refractive index difference is obtained. An objective variable 3 (feature amount “C/D”) indicates the slope of the profile. The feature amount “C” is a relative refractive index difference that is ½ of the maximum relative refractive index difference, the feature amount “D” is a distance from a radial position at which the relative refractive index difference is the maximum relative refractive index difference to a radial position at which the relative refractive index difference is ½ of the maximum relative refractive index difference, and the ratio “C/D” thereof is the objective variable 3. An objective variable 4 (feature amount “E”) represents the maximum relative refractive index difference.

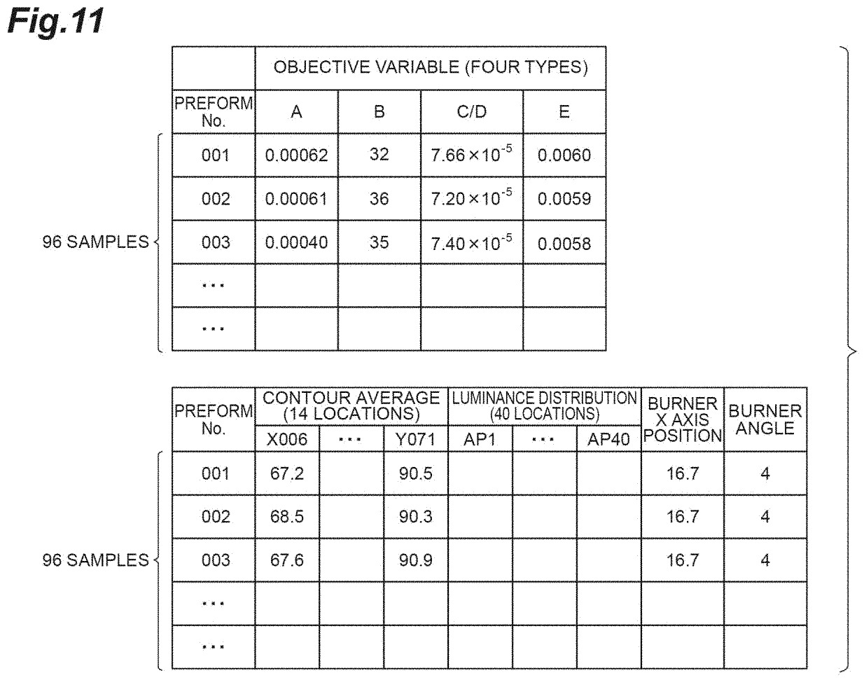

FIG. 11 illustrates part of data (explanatory variable and objective variable) used to construct the learning model in the present embodiment. In the present embodiment, data was acquired from 71 preform samples having a “scissor type” refractive index profile, 14 preform samples having a “chevron type” refractive index profile, and 11 preform samples having a “trapezoid type” refractive index profile. In the present embodiment, the learning model is constructed using all the data (explanatory variables and objective variables) except the test target, and the error between the measured value of the test target and the prediction value of the learning model is evaluated by root mean square error (RMSE).

RMSE: root-mean-square error ((1/n)×Σ(true value−prediction value)²)^{½}

n: number of data

In FIG. 11, explanatory variables (measured values) and objective variables (measured values) of each of a total of 96 preform samples classified as described above are shown. In the upper part of FIG. 11, data of four types of objective variables (A, B, C/D, E) is illustrated for each preform sample. The lower part of FIG. 11, explanatory variables are configured by a total of 56 types of data including a contour coordinate average value at each of seven locations in the region GB and a contour coordinate average value at each of seven locations in the region GA illustrated in FIG. 7, luminance data at 40 locations illustrated in FIG. 8, a burner X-axis position, and a burner angle, and these 56 types of data constituting the explanatory variables are shown for each preform sample.

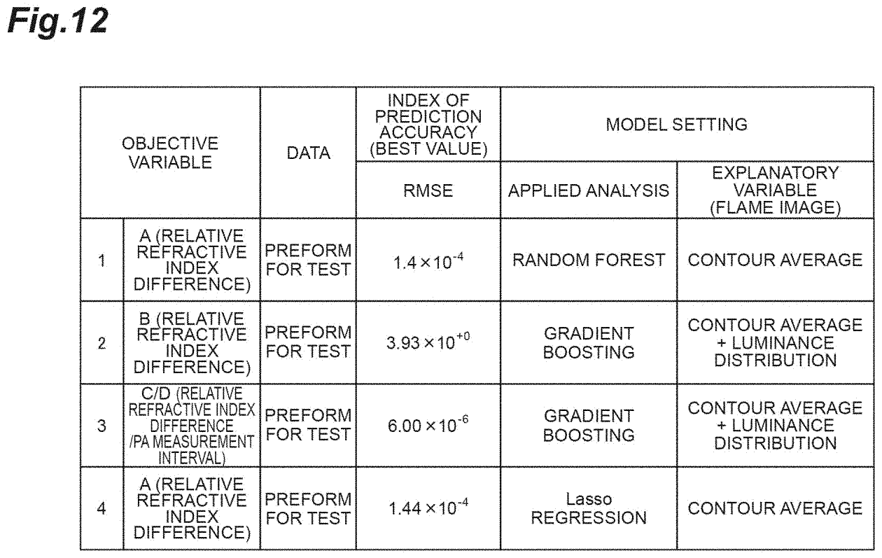

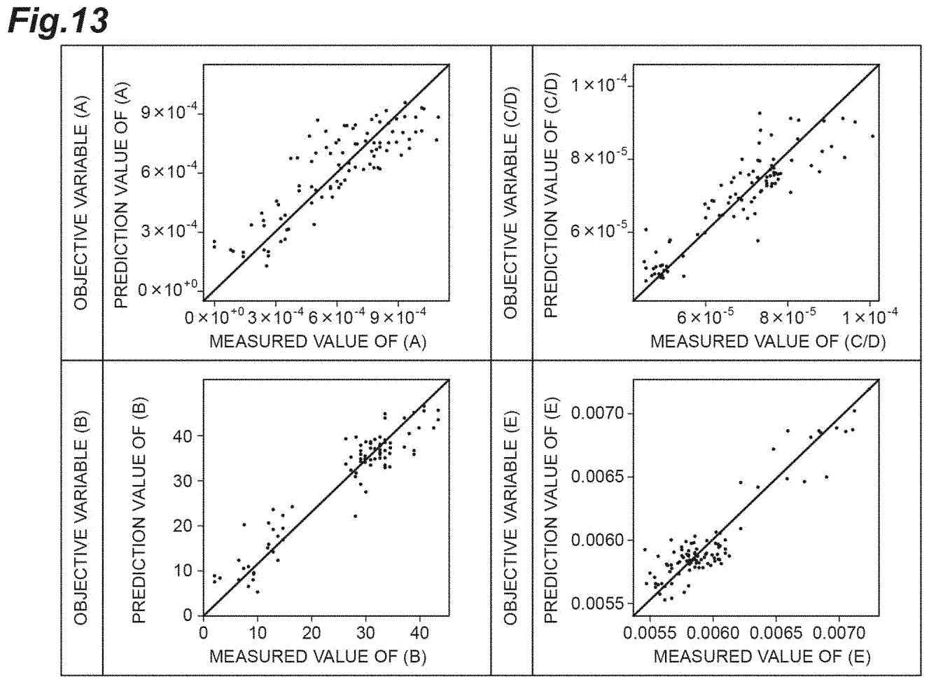

FIG. 12 illustrates an analysis method in which the prediction accuracy is the highest for each objective variable in the preform profile prediction of the present disclosure, and its accuracy (RMSE). FIG. 13 is a graph illustrating a correlation between prediction values and measured values of the objective variable.

As illustrated in FIG. 12, the calculation unit 105 predicts the objective variable 1 (feature amount “A”) using the random forest with the highest accuracy as the regression prediction of the objective variable 1. The contour data of the particle flow in the flame, the luminance distribution data of the particle flow, and the burner position (burner X-axis position and burner angle) were determined as explanatory variables through the basic analysis shown in FIGS. 4 and 9. In addition, the calculation unit 105 predicts the objective variable 2 (feature amount “B”) and the objective variable 3 (feature amount “C/D”) using the gradient boosting with the highest accuracy as regression prediction of the objective variable 2 and the objective variable 3. Furthermore, the calculation unit 105 predicts the objective variable 4 (feature amount “E”) using the Lasso regression with the highest accuracy as the regression prediction of the objective variable 4.

As can be seen from FIG. 13, regarding any of the objective variable 1 to the objective variable 4, a significant correlation can be confirmed between the prediction values and the measured values of the objective variable.

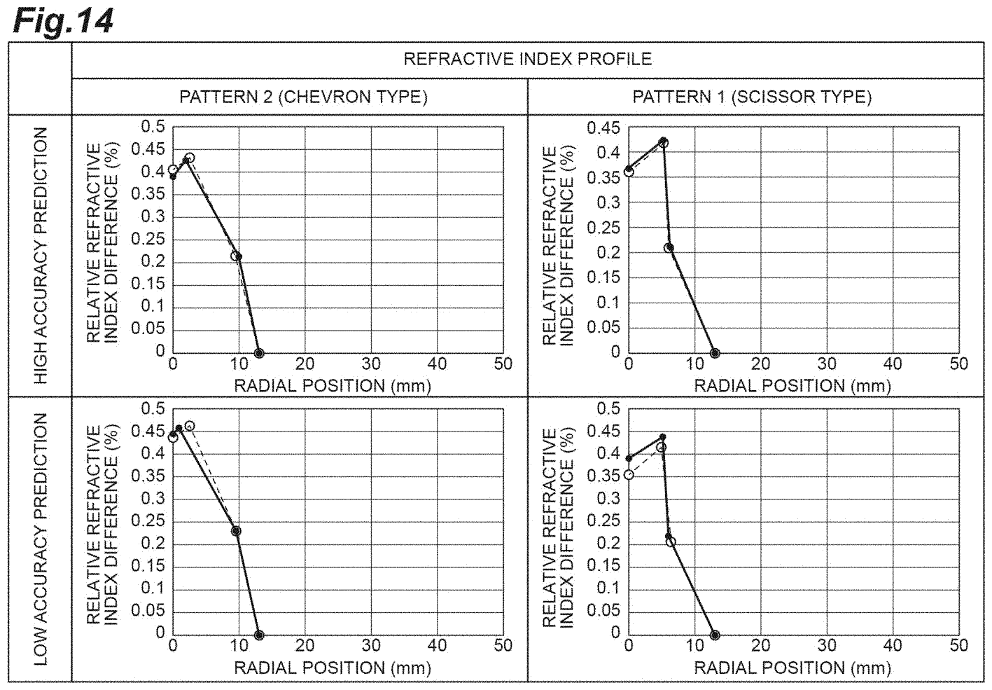

FIG. 14 is a preform profile predicted by the preform profile prediction method referred to in paragraphs “0053” to “0059”. A solid line indicates an actually measured refractive index profile, and a broken line indicates a predicted profile. It can be seen that regression prediction is performed with high accuracy in both the pattern 2 “chevron type” and the pattern 1 “scissor type”.

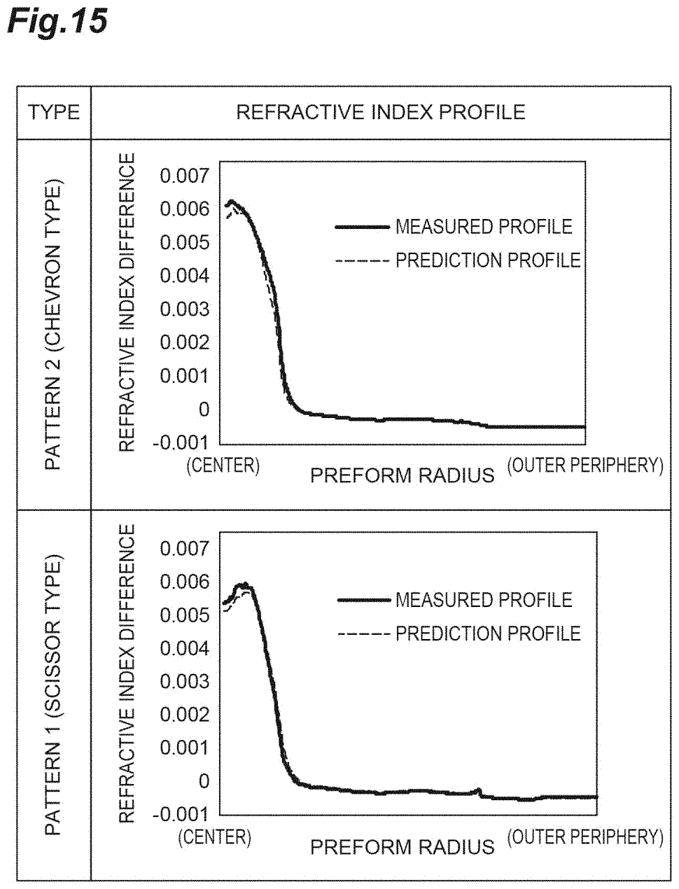

FIG. 15 illustrates a result of regression prediction of all points (500 points in the radial direction) of the refractive index profile only in the random forest. The solid line indicates the measured profile, and the broken line indicates the predicted profile. It can be seen that the preform profile can be predicted with high accuracy only by one type of learning model.

### REFERENCE SIGNS LIST

10 glass preform production apparatus

11 reactor

12 support rod

13 starting glass rod

14 glass particulate deposit

15 lifting and lowering rotation device

16 control unit

17 core burner

18 cladding burner

19 gas supply system

20 driving unit

21 measuring camera

22 signal processing unit

23 image analysis unit

24a, 25a angle adjustment mechanism

24, 25 stage

29 exhaust duct

RA imaging area

102 filter

103 CCD camera (imaging device)

104 signal processing unit

105 calculation unit

106 output unit

110 Personal computer (PC).

1. A glass preform production apparatus for producing a glass particulate deposit by a VAD method, the glass preform production apparatus comprising:
a gas supply system configured to individually supply a glass raw material gas and a fuel gas;
a burner configured to generate glass fine particles from the glass raw material gas in a flame obtained by combustion of the fuel gas supplied from the gas supply system, the burner being configured to blow the glass fine particles in the flame onto the glass particulate deposit; and
a profile prediction system configured to output, at any one or more time points during a period from a start of production to an end of production of the glass particulate deposit, a prediction result of a refractive index profile of a transparent glass preform obtained by dehydration and sintering of the glass particulate deposit, wherein
the profile prediction system includes
an imaging device configured to image the flame generated in the burner or a particle flow of the glass fine particles generated in the flame, and
a calculation unit configured extract image data representing a state of at least the flame or the particle flow from an image obtained by the imaging device and to regressively predict the refractive index profile of the transparent glass preform serving as an objective variable from an explanatory variable including the image data.

2. The glass preform production apparatus according to claim 1, wherein
the explanatory variable includes at least contour data of the flame or contour data of the particle flow in the flame.

3. The glass preform production apparatus according to claim 2, wherein
the explanatory variable further includes at least any one of luminance distribution data of the flame or the particle flow, data obtained by quantifying an installation position and an installation angle of the burner, flow rate data of the glass raw material gas introduced into the burner, flow rate data of the fuel gas, a temperature in a heating furnace during the dehydration and sintering, and a gas flow rate supplied into the heating furnace during the dehydration and sintering.

4. The glass preform production apparatus according to claim 1, wherein
the objective variable includes data characterizing the refractive index profile of the transparent glass preform.

5. The glass preform production apparatus according to claim 1, wherein
the calculation unit regressively predicts the refractive index profile of the transparent glass preform using a regression analysis including one or more of decision tree regression, random forest, gradient boosting, multiple regression, and Lasso regression for each type of data serving as the objective variable.

6. The glass preform production apparatus according to claim 1, further comprising:
a filter disposed between the imaging device and a space sandwiched between the glass particulate deposit and the burner, the filter configured to transmit light with a predetermined wavelength from the particle flow.

7. A glass preform production method by producing a glass particulate deposit by a VAD method and dehydrating and sintering the glass particulate deposit in a heating furnace, the method comprising:
a gas supply step of individually supplying a glass raw material gas and a fuel gas to a burner;
a deposition step of generating glass fine particles from the glass raw material gas in a flame obtained by combustion of the fuel gas supplied to the burner, and blowing the glass fine particles in the flame onto the glass particulate deposit; and
a prediction step of predicting, at any one or more time points during a period from a start to an end of the deposition step, a refractive index profile of a transparent glass preform obtained by dehydration and sintering of the glass particulate deposit, wherein
the prediction step includes an imaging step of imaging the flame generated in the burner or a particle flow of glass fine particles generated in the flame, and
a calculation step of extracting image data representing a state of at least the flame or the particle flow from an image obtained in the imaging step and regressively predicting the refractive index profile of the transparent glass preform serving as an objective variable from an explanatory variable including the image data.

8. The glass preform production method according to claim 7, wherein
the explanatory variable includes at least contour data of the flame or contour data of the particle flow in the flame.

9. The glass preform production method according to claim 8, wherein
the explanatory variable further includes at least any one of luminance distribution data of the flame or the particle flow, data obtained by quantifying an installation position and an installation angle of the burner, flow rate data of the glass raw material gas introduced into the burner, flow rate data of the fuel gas, a temperature in a heating furnace during the dehydration and sintering, and a gas flow rate supplied into the heating furnace during the dehydration and sintering.

10. The glass preform production method according to claim 7, wherein
the objective variable includes data characterizing the refractive index profile of the transparent glass preform.

11. The glass preform production method according to claim 7, wherein
the calculation step includes regressively predicting the refractive index profile of the transparent glass preform using a regression analysis including one or more of decision tree regression, random forest, gradient boosting, multiple regression, and Lasso regression for each type of data serving as the objective variable.

12. A preform profile prediction method for predicting, at any one or more time points during a period from a start of production to an end of production of a glass particulate deposit, a refractive index profile of a transparent glass preform obtained by dehydration and sintering of the glass particulate deposit produced by a VAD method, the preform profile prediction method comprising:
an imaging step of generating glass fine particles from a glass raw material gas supplied to a burner in a flame obtained by combustion of a fuel gas supplied to the burner and imaging, at any time points when the glass fine particles in the flame are blown onto the glass particulate deposit, the flame generated by the burner or a particle flow of the glass fine particles generated in the flame;
an image processing step of extracting image data representing a state of the flame or the particle flow from an image obtained in the imaging step; and
a calculation step of regressively predicting the refractive index profile of the transparent glass preform serving as an objective variable from an explanatory variable including at least the image data extracted in the image processing step.

13. The preform profile prediction method according to claim 12, wherein
the explanatory variable includes at least contour data of the flame or contour data of the particle flow in the flame.

14. The preform profile prediction method according to claim 13, wherein
the explanatory variable further includes at least any one of luminance distribution data of the flame or the particle flow, data obtained by quantifying an installation position and an installation angle of the burner, flow rate data of the glass raw material gas introduced into the burner, flow rate data of the fuel gas, a temperature in a heating furnace during the dehydration and sintering, and a gas flow rate supplied into the heating furnace during the dehydration and sintering.

15. The preform profile prediction method according to claim 12, wherein
the objective variable includes data characterizing the refractive index profile of the transparent glass preform.

16. The preform profile prediction method according to claim 12, wherein
the calculation step includes regressively predicting the refractive index profile of the transparent glass preform using a regression analysis including one or more of decision tree regression, random forest, gradient boosting, multiple regression, and Lasso regression for each type of data serving as the objective variable.

17. The glass preform production apparatus according to claim 3, wherein
the calculation unit regressively predicts the refractive index profile of the transparent glass preform using a regression analysis including one or more of decision tree regression, random forest, gradient boosting, multiple regression, and Lasso regression for each type of data serving as the objective variable.

18. The glass preform production method according to claim 9, wherein
the calculation step includes regressively predicting the refractive index profile of the transparent glass preform using a regression analysis including one or more of decision tree regression, random forest, gradient boosting, multiple regression, and Lasso regression for each type of data serving as the objective variable.

19. The preform profile prediction method according to claim 14, wherein
the calculation step includes regressively predicting the refractive index profile of the transparent glass preform using a regression analysis including one or more of decision tree regression, random forest, gradient boosting, multiple regression, and Lasso regression for each type of data serving as the objective variable.
